(19) United States
(12) Patent Application Publication
(10) Pub. No.: US 2013/0218549 A1
(43) Pub. Date: Aug. 22, 2013

(54) DYNAMIC TIME VIRTUALIZATION FOR SCALABLE AND HIGH FIDELITY HYBRID NETWORK EMULATION

(71) Applicant: TT GOVERNMENT SOLUTIONS, INC., (US)

(72) Inventors: Florin SULTAN, Princeton, NJ (US); Alexander POYLISHER, Brooklyn, NY (US); Constantin SERBAN, Metuchen, NJ (US); Cho-Yu Jason CHIANG, Clinton, NJ (US); John LEE, Howell, NJ (US); Ritu CHADHA, Hillsborough, NJ (US)

(73) Assignee: TT GOVERNMENT SOLUTIONS, INC., Piscataway, NJ (US)

(21) Appl. No.: 13/767,777

(22) Filed: Feb. 14, 2013

Related U.S. Application Data
(60) Provisional application No. 61/599,738, filed on Feb. 16, 2012.

(51) Int. Cl. G06F 9/455

(52) U.S. Cl. CPC G06F 9/455
USPC 703/19

(57) ABSTRACT

A system and method for measurement of the performance of a network by simulation, wherein time divergence is addressed by using discrete event simulation time to control and synchronize time advance or time slow down on virtual machines for large-scale hybrid network emulation, particularly where the loss of fidelity could otherwise be substantial. A dynamic time control and synchronization mechanism is implemented in a hypervisor clock control module on each test bed machine, which enables tight control of virtual machine time using time information from the simulation. A simulator state introspection and control module, running alongside the simulator, enables extraction of time information from the simulation and control of simulation time, which is supplied to the virtual machines. This is accomplished with a small footprint and low overhead.

### CROSS-REFERENCED APPLICATION

This application claims priority from U.S. provisional patent application Ser. No. 61/599,738, filed on Feb. 16, 2012, which is incorporated herein by reference, in its entirety, for all purposes.

### BACKGROUND

1. Field of the Disclosure

The present disclosure relates to network simulation. More particularly, it relates to the measurement of the performance of a network by simulation.

2. Description of the Related Art

Hybrid network emulation comprises primarily a discrete event simulated network and virtual machines (VMs) that send and receive traffic through the simulated network. It allows testing network applications, rather than their models, on simulated target networks, particularly mobile wireless networks. In some hybrid network emulation approaches, applications can run on top of their native operating systems (hereinafter OSs) without any code modification. As result, the same binary executable can be used in both emulated hybrid networks and real networks.

In a sample setup of a virtualized hybrid network emulation test bed, the network simulation runs on a dedicated machine and end-host VMs deployed on test bed machines run the unmodified protocol stacks and applications. All VMs have a corresponding shadow node inside the simulated network, and VMs communicate by injecting traffic into and receiving traffic from their corresponding shadow nodes, via VLAN or other encapsulation mechanisms.

Hybrid network emulation can potentially address both feasibility and scalability concerns associated with testing applications over target networks. With respect to feasibility, as testing applications over a hybrid emulated network only requires the models of network elements, the availability of network element hardware (e.g., next generation radio hardware) will not be an issue, and simulation can allow for testing over various and different network topologies and configurations. With respect to scalability, as simulation is used to enable hybrid network emulation, theoretically the scale of the target network is constrained only by a simulator's capability and hardware resource availability.

While the feasibility argument stands valid, the scalability of hybrid emulation is actually hindered by the time divergence problem: for complex, large-scale simulations, discrete event simulation time advances slower than real time (typically in a non-uniform way), thus distorting packet propagation characteristics. For example, in a hybrid emulated network where the simulation time advances constantly two times slower than real time, the packet propagation latency perceived by applications running on VMs will be twice the expected value dictated by the simulation.

Thus, there is a need to address the time divergence problem if hybrid emulation is to be scalable.

### SUMMARY

The disclosure is directed to a system for simulating operation of a network, comprising: a simulator for simulating operation of the network; and a simulator time clock for providing simulation time to the components of the network, the simulation time being advanced at discrete moments in real time, to advance no faster than the real time when the simulator conducts operations at a pace faster than the real time, and to advance more slowly than the real time when the simulator conducts operations at a pace slower than the real time.

The system further comprises a simulator introspection and control module for extracting time information from the simulator in the form of simulation time and a time slow down factor, and for control of simulation time.

In the system, the simulator and the simulator introspection and control module have access to the real time provided by their underlying hardware platform.

The system further comprises a hypervisor for providing the simulation time and a simulation time advance rate to the simulated components on the hybrid emulated network.

In the system the hypervisor comprises a clock control module, wherein the clock control module receives the simulation time and a time slow down factor. The hypervisor has access to the real time provided by its underlying hardware platform

In the system the hypervisor comprises: a clock control module which receives the simulation time and a time slow down factor and provides updated timeout values, and outputs the simulation time, and the simulation time advance rate; a periodic timer and a one shot timer for each simulated component, receiving the updated timeout values and for outputting timer interrupts; and a system time setting mechanism for receiving the simulation time and the simulation time advance rate; wherein the simulated components of the network receive one of a time interrupt from one of the periodic timer and the one-shot timer, and the simulation time and the simulation time advance rate from the system time setting mechanism.

The simulated components are virtual machines. The virtual machines represent nodes of the network. The time observed by the virtual machines (also referred to “system time” herein) is a piece-wise linear approximation of the actual simulation time, sampled at discrete moments in real time. The discrete moments are at constant time intervals from one another. The simulation time is constrained so as not to advance faster than the real time.

The simulation time is driven by a timestamp of a next event to be processed in the simulation. The simulation time is driven by receipt of a data packet by a node in the network.

The disclosure is directed to a method for simulating operation of a network, comprising: simulating operation of the network; providing time to the components of the network, at discrete moments in real time, to advance time no faster than the real time when a simulator conducts operations faster than the real time, and to advance time slower than the real time when the simulator conducts operations at a pace slower than the real time.

Also disclosed is a computer readable non-transitory storage medium storing instructions of a computer program which when executed by a computer results in performance of steps of a method for disseminating content, comprising: simulating operation of the network; providing simulation time to the components of the network, at discrete moments in real time, to advance time when a simulator conducts operations faster than the real time, and to advance time slower than the real time when the simulator conducts operations at a pace slower than the real time.

To address the time divergence problem, the present disclosure provides a novel system and method that use a discrete event simulation time to control and synchronize time advance on VMs for large-scale hybrid network emulation. To minimize and bound the possible loss of fidelity in the hybrid modeling environments, time synchronization between simulation and the external OS domains becomes a necessity, particularly for large scale models where the loss of fidelity can be substantial. The objectives are: (1) tight constraint on simulation time to advance no faster than real time, (2) tight synchronization of the VM time with simulation time, (3) tight synchronization of the rate of flow of VM time (as perceived by software running inside a VM) with that of simulation time, and (4) a small footprint and low overhead.

As disclosed herein the value of simulation time is tracked in small discrete steps, along with an approximation of its average rate of change between consecutive steps. Following simulation time dynamics in both discrete value and rate of progress is important for good accuracy. Two mechanisms used are (i) simulator side introspection, to extract time information as the simulation is running, and (ii) dynamic time virtualization, to apply this information dynamically to the VMs via a hypervisor-VM interface. The time information includes the value of simulation time at a given instant and its projected rate of progress relative to the real time.

If ST(t) is the simulation time as a function of the real time t, and VT(t) is the virtual time (as perceived by a VM) as a function of real time t, ideally, VT would track ST, i.e., VT(t)=ST(t) for any t. Since in a real system this cannot be done continuously, a piece-wise linear approximation of ST(t) is achieved as follows: Introspection is performed every interval of constant length Δ in real time, by sampling ST=ST(t) and a slowdown factor is predicted SF≧1 of the simulation time in the next interval. Control is accomplished by constraining the simulator to run no faster than real time, which assures that SF is never less than 1. Dynamic time virtualization is accomplished by making VT(ti)=ST at the beginning ti of an interval and by approximating VT(t) inside the interval as a linear function of t, VT(t)=ST+(t−ti)/SF.

A simulator introspection and control module (ICM) samples ST and computes SF every sampling period Δ, then sends them to the clock control module (CCM) on all test bed machines. The CCM, serving as a virtualization mechanism, uses the (ST, SF) tuple to control all aspects of time perceived by VMs involved in the emulation, e.g., VMs' system time, its rate of progress, and timers. VMs run freely under the control of the hypervisor's scheduler, but their time is dynamically virtualized, i.e. VMs' system time is set to ST at the beginning of an interval and flows at a rate of 1/SF until the next update.

The hypervisor comprises a clock control module for receiving simulation time and a time slow down factor and for providing updated timeout values, and which outputs simulation time, and a simulation time advance rate; a periodic timer and a one shot timer for each simulated component, receiving the updated timeout values and for outputting timer interrupts; and a system time setting mechanism for receiving the simulation time and the simulation time advance rate; wherein the simulated components of the network receive one of a time interrupt from one of the periodic timer and the one-shot timer, and the simulation time and the simulation time advance rate from the system time setting mechanism. The simulated components are virtual machines. The virtual machines represent nodes of a network.

The system time is a piece-wise linear approximation of the actual simulation time, sampled at discrete moments in real time. The discrete moments can be at constant time intervals from one another. The simulation time is constrained so as not to advance faster than real time.

Another embodiment of the disclosure is directed to a computer readable non-transitory storage medium storing instructions of a computer program which when executed by a computer system results in performance of steps of the method disclosed herein.

### BRIEF DESCRIPTION OF THE DRAWINGS

FIG. 1 is a block diagram of a high-level architecture of the hybrid network emulation system and method as disclosed herein.

FIG. 2 is a flow chart of an algorithm used by the introspection and control module of FIG. 1.

FIG. 3 is a block diagram of the clock control module of FIG. 1.

FIG. 4 is a graph illustrating an example of the progression of simulation time and VM time in accordance with the disclosure herein.

A component or a feature that is common to more than one drawing is indicated with the same reference number in each of the drawings.

### DESCRIPTION OF THE PREFERRED EMBODIMENTS

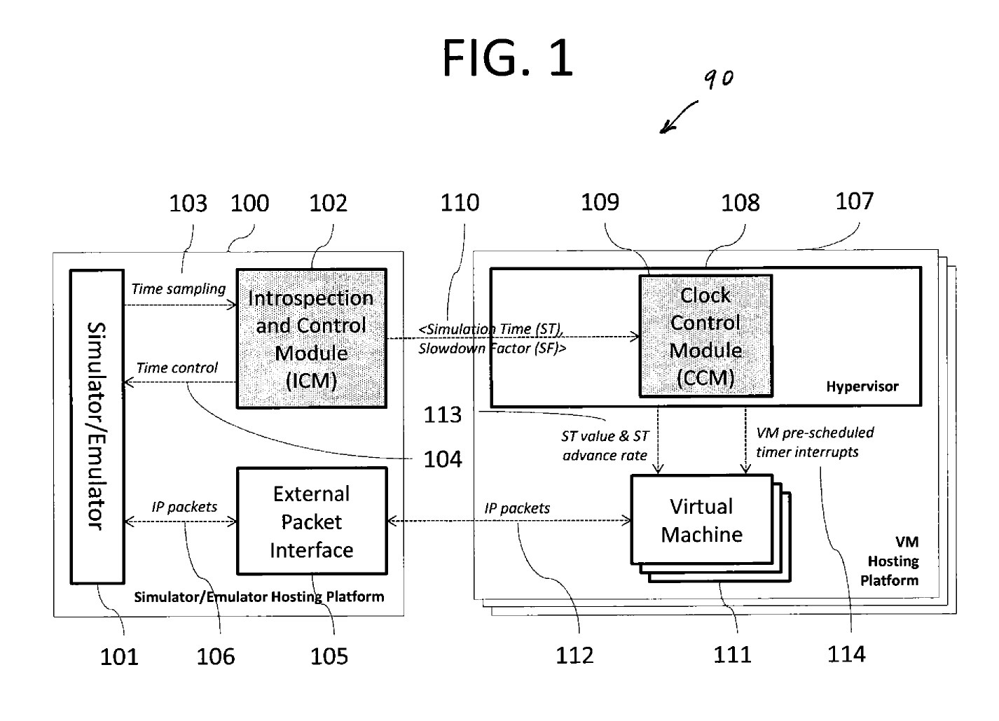

FIG. 1 is a block diagram of a high-level architecture of the hybrid network emulation system 90 and method as disclosed herein. The system 90 consists of a simulator/emulator hosting platform 100 and multiple VM hosting platforms 107. Altogether they form a virtual networked system. Each VM hosting platform 100 runs multiple VMs 111, under the control of a hypervisor 108 (also called a VM monitor). A hypervisor is computer software, firmware or hardware that creates and runs VMs. In one embodiment the hypervisor is Xen which allows multiple computer operating systems to execute on the same computer hardware concurrently.

Simulator/emulator hosting platform 100 runs a simulator/emulator 101 (herein “simulator”). In one embodiment, the simulator can be a commercial discrete-event simulator such as, for example, Qualnet/CES, OPNET, and many others. Simulator 101 uses a predefined network model to provide a simulated network that provides logical network connections between the VMs. The simulated network includes all network layers from the physical layer to the network (IP) layer.

The VMs send and receive IP packets, the exchange of which is represented by 112 through an external packet interface 105 on the simulator 100. The external packet interface 105, as represented by 106, injects IP packets from a VM into the simulated node corresponding to that VM. It also extracts, as represented by 106, IP packets from simulated nodes and forwards them to their corresponding VMs, as represented by 112.

Hypervisor 108 assists the VMs 111 to observe the progression of time. First, hypervisor 108 provides all the VMs under its control with two pieces of system time information, as represented by 113, i.e. (i) the absolute time units from the start of the simulation in the form of a simulation time value ST; and (ii) the current simulation time advance rate, which provides information for hypervisor 108 to calibrate the VMs' system time progression rate rather than depending on the hardware time on the VM hosting platform 107. Hypervisor 108 also controls the delivery of all timer interrupts, as represented by 114 to the VMs 111.

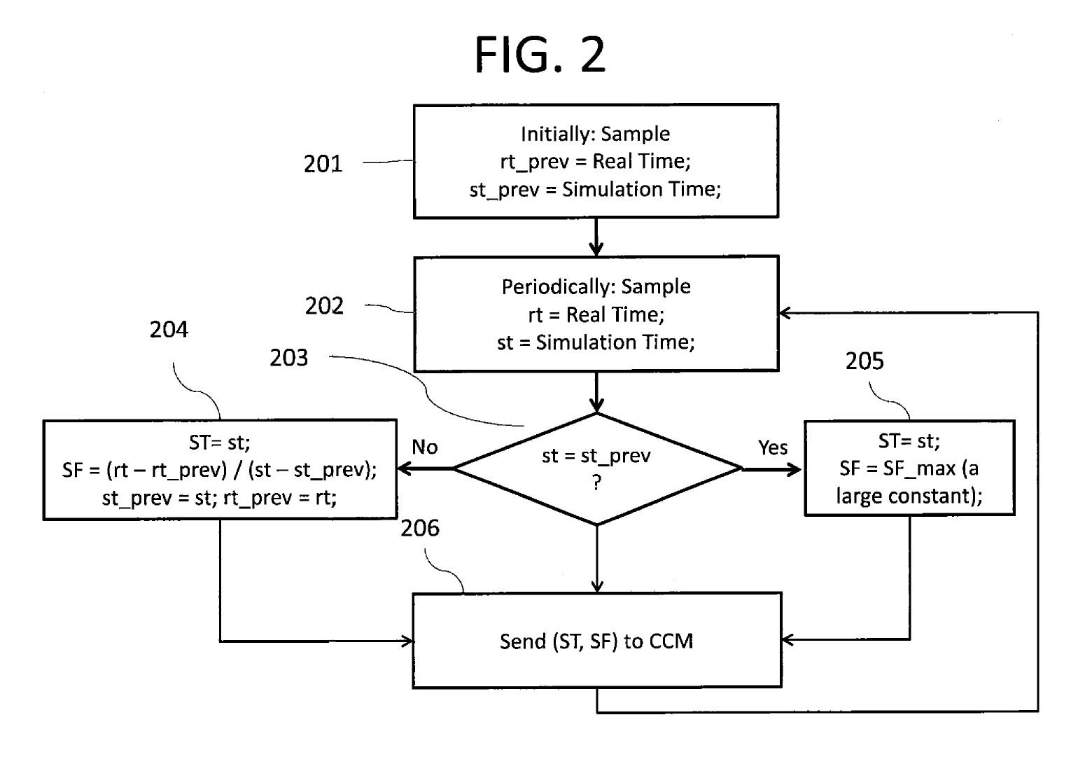

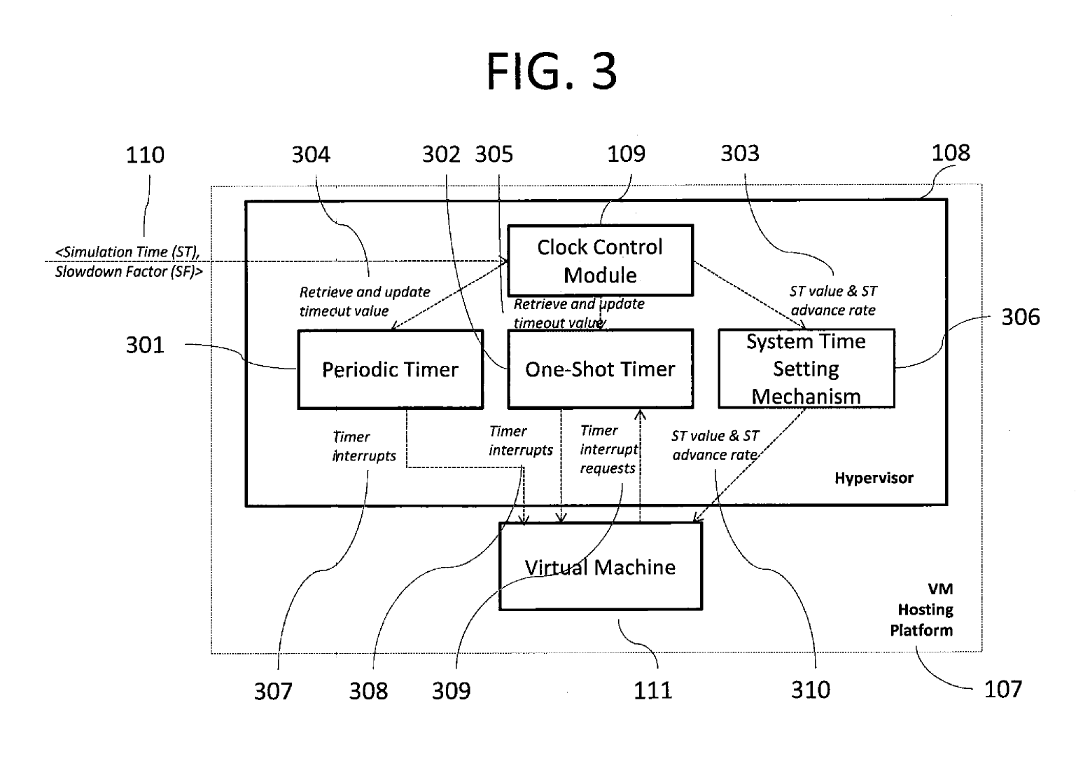

An introspection and control module (ICM) 102 performs an introspection function in order to extract simulation time from the simulator and performs a control function in order to prevent simulation time from progressing faster than real time. ICM 102 performs periodic time sampling, as represented at 103, of the simulation time and the real time. The sampling period Δ is configurable and can be set in the range of milliseconds. In one embodiment Δ is set to 3 milliseconds. Each time ICM 102 receives the time samples, it uses them to derive simulation time (ST) and slowdown factor (SF), which are sent to the CCMs 109 on all VM hosting platforms 107. The function of the CCM will be further explained with respect to FIG. 3. ICM 102 also performs continuous time control, as represented by 104 to ensure that the simulation time will not advance faster than the real time. The algorithm used by ICM 102 is described with respect to FIG. 2.

Hosting platform 100 and VM hosting platform 107 include the components of a computer, including a CPU (in the form of at least one microprocessor), memory, and input output devices. The memory may include a hard disk, which serves as a storage medium that stores, in a non-transitory manner, computer instructions for implementing the methods and portions of the apparatus described herein.

FIG. 2 describes the algorithm that ICM 102 uses to compute the pair (ST, SF). At step 201 rt_prev and st_prev are initialized with the current real time and simulation time, respectively. At step 202 the current real time rt and simulation time st are sampled at the beginning of every sampling period Δ, where Δ represents a real time interval, which is generally a constant. At step 203 the current st and the previous st_prev values are compared. If they are different step 204 is executed; otherwise step 205 is executed. At step 204 ST is set to the current st and computes SF using the relationship:

SF=(rt−rt_prev)/(st−st_prev);

Where the current rt and st samples are saved in rt_prev and st_prev, respectively.

At step 205 ST is set to the current st and SF is set to a large configurable constant value SF_max. In one embodiment SF_max is set to 100. At Step 206 sends (ST, SF) to CCM and then goes back to Step 202, which will execute again when the time is up to take the next samples.

FIG. 3 describes the operation of CCM 109, and how it interacts with other modules to perform dynamic time virtualization for a single VM 111 on a single physical hardware platform 107. The operation of CCM 109 is similar and concurrent for all the other VMs under the control of hypervisor 108, and on every VM hosting platform 107 in the system.

In one embodiment, the CCM 109 is integrated with the Xen hypervisor 108. Xen and other hypervisors provide a measure of time to every VM using two types of mechanisms: (i) a system time setting mechanism for setting the system time of the VMs 306, and (ii) VM timers in the form of a periodic timer 301 that generates periodic timer interrupts, represented by 307, and a one-shot timer 302 that generates one timer interrupt, represented by 308, at a defined timeout requested by the VM, as represented by 309.

It will be understood that each VM hosting platform may have multiple processing cores (physical CPUs), and that each core can run a VCPU (virtual central processing unit) that belongs to some VM. In the implementation disclosed herein, each VM has one VCPU. However, the same idea can be applied when a VM has multiple VCPUs since each VCPU has its own pair of timers 301 and 302 and its own system time setting mechanism 306.

In Xen, timers are software timers programmed by Xen with timeouts measured in the real time provided by the physical hardware platform of system 90. Xen receives a periodic hardware timer interrupt from the physical hardware platform. As part of processing this interrupt, it evaluates the periodic timer 301 and one-shot timers 302 that the Xen hypervisor maintains for the VM. When a timer expires, it sends a virtual timer interrupt to the target VM 111.

At periodic time intervals Δ, CCM 109 receives, as represented by 110, the two values computed by ICM 102 as described before: ST (simulation time) and SF (slowdown factor).

CCM 109 uses (ST, SF) to control all aspects of time perceived by a VM 111: system time, its advance rate, and the two timers. VM 111 runs freely, under the control of the hypervisor scheduler, but its perception of time is controlled by the CCM 109: VM system time is set to ST at the beginning of an interval, when CCM 109 receives (ST, SF), and then flows at a rate of 1/SF until CCM 109 receives the next (ST, SF).

In one embodiment, the Xen hypervisor 108 is modified to implement the CCM 109 to dynamically control the advance of the system time for paravirtualized VMs (PVMs). The Xen-VM time interface is used to set the system time of the VM 111 to ST, and to set its rate of system time advance to 1/SF with respect to the rate of time flow on the physical hardware platform hosting the VM 111. The expiration timeouts of the VM timers (the periodic timer 301 and one-shot timer 302) are adjusted so that they correctly expire in the new timeframe with an advance rate of time slowed down by 1/SF.

The following describes the details of CCM 109 actions. To control the VM 111 system time, CCM 109 performs the following actions:
CCM 109 uses ST as represented by 110 as system time value (ST value) for the VM 111 system time.
CCM 109 computes the rate of advancement for the VM's system time with respect to the real time. The ST advance rate is equal to 1/SF.
CCM 109 sends the ST value and the ST advance rate to the VM 111, as represented by 303 using the system time setting mechanism 306.

In a particular embodiment in which the hypervisor is Xen, and the VM is a PVM, and the hardware platform uses an x86 architecture processor providing a TSC cycle counter, the system time setting mechanism 306 is a shared memory page called shared information page, written by the hypervisor 108 and read by the OS running inside the VM 111. The ST advance rate is a processor-specific multiplication factor for converting into nanoseconds the intervals of time that the VM 111 measures in processor cycles using the processor TSC counter. CCM 109 divides the current multiplication factor by SF and writes it to the shared information page. It also writes the ST value to the shared information page along with the current TSC value. The OS of the VM 111 reads these three values from the shared information page and uses them along with the current value of the TSC to compute its virtualized system time whenever needed at any moment in the future.

In order to control the initial timeouts for the timers, CCM 109 performs the following actions:
When hypervisor 108 arms the periodic timer, CCM 109 retrieves the timeout value T as represented at 304 and multiplies it by the current SF in effect in order to obtain an inflated period in real time T′=T*SF. CCM 109 then updates the periodic timer 301 with T′ as the new timeout value as represented at 304.
When the VM requests an interrupt from the one-shot timer 302 with a timeout T,

CCM 109 retrieves T from one-shot timer 302 and updates it to a new timeout T′=T*SF as represented at 305.

In a particular embodiment of the invention in which the hypervisor is Xen and VM is a PVM, the VM expresses the one-shot timeout T in absolute VM system time. In this case, to derive a relative timeout for the timer, the CCM maintains an estimate st_est of the VM's current system time. It computes a relative virtual timeout VT in the VM's timeframe by subtracting st_est from T: VT=T−st_est. It then scales the relative virtual timeout by SF to obtain the timer timeout T′=VT*SF, and updates the one-shot timer 302 timeout with T′ as represented at 305.

To dynamically control the timeouts of the VM timers, upon receiving a new SF value from ICM 102, CCM 109 performs the following actions for both the periodic timer 301 and the one-shot timer 302:
If the timer is running, CCM 109 retrieves the remaining timeout value T of the timer that the hypervisor 108 maintains in real time as represented by 304 and 305.
CCM 109 converts T into a virtual timeout VT in the current VM's timeframe by dividing it by the previous SF value: VT=T/SF_prev.
CCM 109 then converts VT into a new real time timeout T′ in the new VM timeframe by multiplying it by the SF value: T′=T*SF.
CCM 109 updates the timeout value of the timer with T′ as represented at 304 and 305.

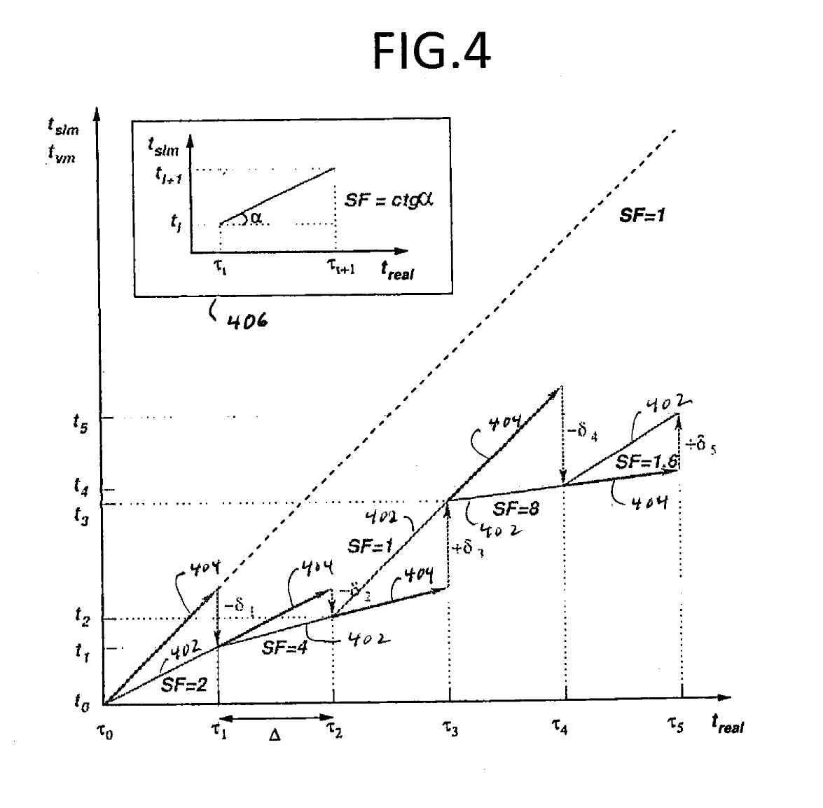

FIG. 4 illustrates the impact of this dynamic time control mechanism on the time progression in a VM 111. The x axis shows the discrete moments in real time at which a (ST, SF) update is injected into CCM 109 of the Xen hypervisor 108. Curve 402, including a series of lines, depicts the progression of simulation time used as a reference for sampling ST and for computing each SF value. Curve 404, also including a series of straight lines, shows the progression of VM system time.

Every time CCM receives an (ST, SF) update (every sampling period), the dynamic time virtualization mechanism implemented by the CCM 109 actions as described above forces the VM system time up or down by a difference δᵢ, in an attempt to set it to the exact simulation time. In addition, an update adjusts VM timers and changes the progression rate of VM system time according to the predicted SF value in the next interval. As a result, in each interval between two updates the curve 404 grows linearly with the same slope that the curve 402 had exhibited in the previous interval (the inverse of the predicted SF). This causes the divergence between the two curves seen in the figure over each interval, marked by δᵢ at the end of an interval (where i=1, 2, 3, . . . ). However, as the vertical arrows show, at the end of each interval this divergence is corrected by a new incoming update that forces the VM system time to the most recent simulation time sample ST received in the update. The error induced by SF prediction is bounded by Δ (reached only if the predicted SF was 1 but the real SF was infinity). Because the interval between updates is small (Δ is on the order of milliseconds), the instantaneous divergence between the two curves is small.

In the graph 406, which shows a plot of simulation time versus real time between successive discrete times, SF=ctg α, where:

ctg is the cotangent function, and

α is the slope of the line.

Basic principles of time maintained in the VMs 111 by guest OSs, and the mechanisms Xen uses to provide time-related information to the guest OSs are discussed below. In addition, the details of a CCM implementation in Xen are discussed. By way of example, the details are limited to x86 CPUs, Xen 3.3.2, Unix-like guest OSs, such as for example, Linux and NetBSD, and paravirtualized (PV) guests.

To support time services, a guest OS maintains two variables: (i) the system time (as nanoseconds elapsed since boot time), and (ii) a counter of interrupts (ticks) generated by a periodic hardware timer at a fixed rate (e.g., denoted by HZ in Linux and BSD systems, with typical values of 100 or 1000 ticks/s). Alternatively, to reduce interrupt overhead, some guest OSs (including Linux) can eliminate the periodic timer 301 discussed above and run in the so-called tickless mode, in which the OS programs the one shot timer 302 to fire at the precise future moment when it needs to process an event. As such an event is usually expected much later than the next periodic timer interrupt would have regularly occurred, the one shot timer 302 eliminates useless interrupt overhead.

Xen has two interfaces for communicating time-related information with a guest. These are Xen-to-Guest and Guest to Xen.

In the Xen-to-Guest interface Xen passes information to a guest via a shared memory region called the shared information page, as discussed above. A guest kernel reads the shared information page to retrieve, among other things, time information dynamically updated by Xen as the system runs. The shared information page holds an array of per-VCPU (virtual central processing unit) structures, each of which contains a vcpu_time_t structure. This, along with other fields in the shared information page that hold the wall-clock value at guest boot time, is used by Xen to implement time keeping on behalf of guests. In addition, Xen provides to every guest VCPU a virtual periodic timer (with a default period of 10 ms) that the guest can arm to within a 1 ms period, and the optional one-shot timer 302 discussed above. Depending on configuration, Linux guests may use the periodic timer for getting periodic virtual interrupts from Xen. Other guests (e.g., NetBSD) do not rely on the periodic timer at all, using instead the one-shot timer 302, which these guests arm on every timer interrupt.

The Guest-to-Xen interface is a hypercall interface. A guest can make hypercalls into Xen to set the platform wall-clock time, and to schedule periodic and one-shot timers 302. The hypercalls of interest are the timer hypercalls (rather than the wall-clock timer hypercalls), since only a privileged guest (Dom0) can set the platform wall-clock time. The hypercall interface provides primitives that manipulate, for each VCPU, e.g., (i) the periodic timer (start/stop); and (ii) the one shot timer 302 (start). The periodic timer 301 delivers virtual interrupts to the VCPU with the desired period. The one-shot timer 302 delivers a single interrupt to the VCPU at a target guest system time specified as an argument to the hypercall. A VCPU programs the one-shot timer 302 prior to relinquishing the CPU to schedule a timer interrupt at the time the VCPU needs to process a known event (e.g., the next expiring guest timer).

In Xen, the VM system time is an abstraction of the time in nanoseconds (ns) elapsed since the system was booted. This assumes an ideal, global notion of time, uniformly and instantly available to all CPUs, as, for example in a Symmetric MultiProcessing (SMP) system, which is a multiprocessing architecture in which multiple CPUs, residing in one cabinet, share the same memory. SMP systems provide scalability; as needs increase, additional CPUs can be added to deal with increased transaction volume.

The TSC time is the number of CPU cycles that have elapsed since an arbitrary point in the past (provided by the 64-bit x86 Time-Stamp Counter CPU register). Xen uses the TSC time elapsed since a reference point to compute the current system time by adding the difference between two TSC samples (current, and the reference), multiplied by a TSC-to-ns conversion factor (denoted by mf), to the system time at the reference point. In practice, to implement the system time abstraction efficiently on multi-CPU systems, Xen employs several approximations and optimizations. First, it maintains local (per-CPU) time variables independently on each physical CPU to track the last “good” known value of system time, along with the mf with respect to the TSC of that CPU. Second, on any given CPU, Xen does not continually maintain and update the CPU-local system time variable. Instead, it computes system time as follows: (i) periodically records a reference value of the system time, (ii) computes the TSC time elapsed since the last system time reference value, (iii) converts the TSC time elapsed to ns of real time using the CPU-local mf factor, and (iv) adds the value in ns to the reference system time to obtain the current system time.

Since the rate of TSC change may vary over time (e.g., due to fluctuations in clock frequency), Xen performs time calibration every second, with two goals. First, it retrieves a “good” reference system time from a reliable time source and distributes it to all active CPUs. Second, it re-computes a new mf factor for each CPU, to be used until the next calibration event. These values are stored on each CPU in two CPU-local time variables.

To provide time information for a guest domain, Xen (i) pushes updates of system time to the guest, and (ii) manages periodic timer 301 and one-shot timers 302 on behalf of the guest. These take place independently and individually for each guest VCPU. Xen uses three (logical) fields in the vcpu_time_t structure in the shared info page to pass CPU-local time information to a VCPU: (i) st: local reference system time at the last calibration on the CPU, (ii) ts: local TSC stamp at the time of the last calibration, and (iii) mf: the multiplication factor used by the VCPU when converting TSC time intervals into real time for its own computation of the current system time.

The T=(st, ts, mf) triple provided by Xen to a guest VCPU is exactly the same that Xen itself uses to compute internally its system time on a given CPU, so it is specific to the current CPU that executes the VCPU time update. Moreover, guest kernels derive an estimate of the system time from T using a TSC-based scheme similar to that of Xen. Since guest accesses to the TSC are not virtualized this creates a dependency on the physical platform. Xen updates the time information of a guest VCPU in three instances:
(i) When the VCPU is scheduled for execution, but only if a time calibration has taken place while the VCPU was not running.
(ii) When the VCPU is rescheduled on a different CPU than the one on which it has last run.
(iii) When time calibration occurs on the underlying CPU. In principle, a guest VCPU could read its time triple T from the shared information page and use it directly to compute the system time using the formula stₓₑₙ=st+(TSC−ts)*mf.

The guest kernel neither uses stₓₑₙ directly, nor does it count the timer interrupts received. Instead, it maintains its own view of system time in a system-wide variable (processed_system_time, or PST, in ns) that it advances in full increments of ticks at HZ frequency. On every timer interrupt received by a VCPU, the guest kernel:
(i) Computes st^{xen} using the formula above.
(ii) Compares stₓₑₙ with its PST and checks if at least a tick (at its own HZ rate) has passed since the last PST update; if so, it updates PST by a whole number of elapsed ticks, in ns.
(iii) Increments its tick counter (jiffies, ticks, etc.) by this number of ticks.
   This mechanism shields the guest OS from vagaries of virtual interrupt delivery by Xen, the most conspicuous of which is the loss of timer interrupts while guest VCPUs are not running. If virtual timer interrupts are lost or delayed, the guest will always advance its view of system time on the first interrupt it receives, and will make up for the lost/delayed interrupts strictly based on its own timer period (HZ) and the TSC time elapsed since its last PST update. Also, because the guest does use the computed stₓₑₙ as a reference for comparison with its own PST (as above), it will resist changes in the st value that push stₓₑₙ back with respect to PST and will catch up with stₓₑₙ if this jumps forward with respect to PST. This creates an asymmetry in the way the guest reacts to time updates from Xen. Due to the guest maintaining its own notion of system time, any dynamic time virtualization scheme cannot know it and will have to make assumptions about its value at a given instant. Specifically, it is reasonable to assume that the guest computes stₓₑₙ using the formula above, and does this immediately when the triple T is provided by Xen.

To keep the progression of guest time in sync with an external time source (such as the time progression generated by a network simulator), the Xen-guest time interface is exploited to virtualize both the absolute system time and the rate of time progression as perceived by the guest. A thin layer of virtualization is introduced by the CCM 109 implementation along with a simple API through which an external Dom0 process can dynamically control the st and mf parameters in the Xen-VCPU time interface. This enables: (i) fine-grained dynamic corrections to st, and (ii) specifying the rate at which time elapses in the guest. Given an external time source that provides a pair of a system time value ST, along with a desired slowdown factor SF of the rate of time progression, the following are implemented:

1. A xenct1 call toggle_slowdown( ) that allows a Dom0 process to dynamically turn on and off time virtualization for several VMs.

2. A xenct1 call set_slowdown( ) that allows a Dom0 process to specify the (ST, SF) pair to a list of VMs.

3. A mechanism for propagating changes in (ST, SF) to the target VMs. Dynamic slowdown for single-VCPU VMs and multiple VCPU VMs are both contemplated.

4. A mechanism for scaling the VCPU periodic timer 301 and one-shot timers 302 according to the currently effective SF and for dynamically updating the active VCPU timers on a change in SF, so that they would expire correctly in the new timeframe of the guest. For each VCPU, fields of the time triple T in its vcpu_time_t structure are controlled to supply to the VCPU a virtualized time triple Tᵥ=(stᵥ, tsᵥ, mfᵥ), where:

tsᵥ=ST if ST is available, stₑₛₜ otherwise.
tsᵥ=TSC stamp at a Tᵥ update or CPU switch, and
mfᵥ=mf/SF.

Here, stₑₛₜ is a running estimate of the guest time that is maintained dynamically inside Xen, as a function of the sequence of all past SF seen since time virtualization has been turned on. To allow for fractional SF>1 values, since Xen performs only integer arithmetic, the input SF is multiplied by a fixed precision factor (e.g., 104 for 4-decimal precision) to obtain an integer, scale mf by the same factor and perform integer division in Xen, rounding the remainder. Due to the intrinsic dependency of both Xen and guest timekeeping on CPU-local parameters such as the TSC conversion factor mf, all parameters cannot be fully virtualized by just updating Tᵥ when (ST, SF) changes. Besides propagating any change in SF via mfᵥ, Xen is followed in propagating changes to the CPU-specific conversion factor mf due to calibration or the VCPU being scheduled on a different CPU. This dependency may change in more advanced versions of Xen.

All changes to time-related parameters (ST,SF) are propagated in a controlled fashion, lazily, generally only upon scheduling a target VCPU for execution. This is important as the set_slowdown( ) call most often executes on a different CPU from the ones running target VCPUs. This call must propagate Tᵥ values consistently from the CPU on which the target VCPU is executing, perform timer updates based on the (unknown) state of its timers, and avoid racing with the scheduler on the target CPU. Thus, Tᵥ propagation is deferred until the target VCPU is about to be (re)scheduled and the scheduler can execute the propagation code on the same CPU as the target VCPU.

When a timer is first programmed, the timeout value requested by the guest is scaled by the current SF in effect. This is easy for the periodic timer because it has a fixed period and is controlled only by Xen: it is started when a VCPU is about to be scheduled or whenever the timer fires, and stopped when a guest VCPU blocks and yields the CPU. Also, since the periodic timer timeout is relative to Xen system time, it is multiplied by the effective SF to get a linearly slowed down timer. Manipulation of the one shot timer 302 is more complex: (i) it is only started by the guest kernel, and can be programmed with unpredictable timeouts based on the guest needs (e.g., to fire when the next guest timer is due); (ii) it is programmed in terms of an absolute target timeout; (iii) the timeout is relative to the guest timeframe and not the Xen timeframe, i.e., the guest computes it based on its PST.

As described above, the guest PST does not follow Xen system time. The discrepancy between guest and Xen system time is present in native Xen. Because of it, when timeouts are small enough, the hypercall the guest uses to start the one-shot timer 302 may start a Xen timer with a timeout into the past (if guest time lags behind Xen system time). The net effect of this lag is an imprecision in delivering the one-shot timer 302 interrupt to the guest, i.e., the one-shot timer 302 will fire sooner than expected by the guest, which will force the guest to reprogram it. The outcome is that the guest gets multiple interrupts for scheduling a single (desired) timer event. All the above three factors need to be taken into account when scaling the one-shot timer 302. This requires converting a timeout from absolute guest timeframe into the Xen timeframe. The following are computed. 1.) an estimate of the current guest time (at the time of the hypercall) based on the time elapsed in Xen since the last Tᵥ change, the estimated guest time stₑₛₜ at that instant, and the current SF in effect; and 2.) the timeout as a relative offset from the estimate of the current guest time, which is then scaled based on the current SF into a relative Xen timeout that is used to program the one-shot timer 302 inside Xen. During this entire process, as in the native Xen system, the unknown is the current guest system time. An attempt is made to compensate for the lack of current guest system time by keeping the running estimate stₑₛₜ.

If the SF changes while VCPU timers are running, their timeouts must be updated. When an SF change from SF_{old} to SF_{new} takes effect (lazily, at the time a VCPU is scheduled), the timer is stopped, the time until the timer is due to expire in the SF_{old} timeframe is computed, re-scaled in the SF_{new} timeframe, and the timer is started with the new timeout. The one-shot timer 302 again poses a subtle problem at an SF change. If the VCPU was blocked and it is using the one-shot timer 302 to schedule a wakeup, it would have programmed it in the SF_{old} timeframe, and will remain blocked (ineligible for execution) until the timer fires. A very large value of SF_{old} would have scheduled a wakeup timer interrupt far into the future. If SF_{new}<SF_{old}, the scheduler will not be invoked (unless some event needs to wake up the blocked VCPU) and the new SF will not take effect until the timer has fired in the old timeframe. This problem is solved by forcing a schedule event for the VCPU to take it out of the blocked state. This allows the guest to receive its new Tᵥ (and thus SF value) from Xen, run, and block again, but not before programming its respective one-shot timer 302 which will now be correctly scaled in the new timeframe.

To synchronize the wall-clock time on the end-host VMs at the beginning of a simulation, the VMs are configured in independent wall-clock mode (i.e., they do not receive updates of wall-clock time from Xen). Inside each VM, a one-time settimeofday( ) call is performed with a common value of the wall-clock time, multicast to all test bed machines from a reference machine before the start of the simulation. At the end of the simulation, the VM wall-clock time is brought up to date.

The Xen-based time virtualization mechanism described above is generic, so it can be driven by any external time source that provides dynamic updates of ST and SF predictions on small time scales. As described above, the (ST, SF) pair is provided by the simulator introspection module ICM 102.

The introspection functionality of ICM 102 is implemented in a separate sampler process that wakes up periodically every sampling period Δ in real time (α=3 ms in one implementation). A process, and not a thread, is used in order to isolate it from interactions with unknown/unavailable simulator code, and to be able to tightly control it, e.g., it is made a real-time process and its CPU affinity is controlled in order to isolate it from the scheduler and ensure it runs accurately on sampling period boundaries. The sampler process communicates with the main simulator process via shared memory: on each invocation, it samples the last processed simulation time st (in shared memory) and records it along with the current real time rt. It then computes SF in the last sampling interval and uses this value as the projected SF value in the next interval, as described above. Since an infinite SF value cannot be handled (possible if simulator time does not advance in a sampling interval), SF is capped at a maximum SFₘₐₓ (100 in one implementation).

ICM 102 sends the tuple (ST, SF) via IP multicast to all VM hosting platforms 107 in the test bed. This message may be sent over a dedicated network, to ensure isolation from other traffic. A privileged Dom0 control process injects the (ST, SF) tuple it receives periodically from ICM 102 into the CCM 109 using the set_slowdown( ) call as described above. At the start of the simulation, the control process calls toggle_slowdown( ) to selectively enable time control by the CCM 109 for VMs 111 used in the emulation. At the end, it calls it again to disable it. The effect of the latter call is to revert the VM timeframe of the target VMs to the default “normal” one as provided by Xen: the CCM 109 resets the VM system time to that of the host machine (as maintained by Xen), and stops scaling the rate of time progression and the timers of the VMs 111.

The simulator control functionality of ICM 102, implemented as part of the simulation process, prevents speedup of simulation time. It advances the simulation in intervals no larger than a small number of simulation time units (100 μs in one implementation). The module continuously samples the last processed simulation time and the real time at which this was recorded. Prior to advancing the simulation, ICM 102 checks if the last processed simulation time is ahead of the last real time, i.e., the simulator is attempting a speedup. If so, it then postpones processing of the next event until the real time has caught up with the simulation time. This mechanism is implemented with a periodic simulation event. This can be changed to take advantage of high-priority, hard deadline events, or by directly modifying the simulator scheduler, where possible.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A system for simulating operation of a network, comprising:
a simulator for simulating operation of said network; and
a simulator time clock for providing simulation time to the components of the network, said simulation time being advanced at discrete moments in real time, to advance time when said simulator conducts operations faster than the real time, and to advance more slowly than the real time when said simulator conducts operations more slowly than said real time.

2. The system of claim 1, further comprising a simulator introspection and control module for extracting time information from said simulator, and for control of simulation time.

3. The system of claim 1, further comprising a hypervisor for providing said simulation time and a simulation time advance rate to the simulated components of the network.

4. The system of claim 3, wherein said hypervisor comprises a clock control module, wherein said clock control module receives said simulation time and a time slow down factor.

5. The system of claim 3, wherein said hypervisor comprises:
a clock control module which receives said simulation time and a time slow down factor and provides updated timeout values, and outputs said simulation time, and said simulation time advance rate;
a periodic timer and a one shot timer for each simulated component of the network receiving the updated timeout values and for outputting timer interrupts; and
a system time setting mechanism for receiving said simulation time and said simulation time advance rate;
wherein said simulated components of said network receive one of a time interrupt from one of said periodic timer and said one-shot timer, and said simulation time and said simulation time advance rate from said system time setting mechanism.

6. The system of claim 1, wherein said simulated components are virtual machines.

7. The system of claim 6, wherein said virtual machines represent nodes of said network.

8. The system of claim 7, wherein said system time is a piece-wise linear approximation of actual simulation time in said simulator, sampled at discrete moments in said real time.

9. The system of claim 1, wherein the discrete moments are at constant time intervals from one another.

10. The system of claim 1, wherein said simulation time is constrained so as not to advance faster than said real time.

11. A method system for simulating operation of a network, comprising:
simulating operation of said network;
providing simulation time to said components of said network, at discrete moments in real time, to advance time when a simulator conducts operations faster than said real time, and to advance more slowly than said real time when said simulator conducts operations more slowly than said real time.

12. The method of claim 11, wherein said simulation time is driven by a timestamp of a next event to be processed in the simulation.

13. The method of claim 11, wherein said simulation time is driven by receipt of a data packet by a node in said network.

14. The method of claim 11, wherein said simulated components are virtual machines.

15. The method of claim 14, wherein said virtual machines represent nodes of a network.

16. The method of claim 11, wherein said system time is a piece-wise linear approximation of actual simulation time in said simulator, sampled at discrete moments in said real time.

17. The method of claim 11, wherein said discrete moments are at constant time intervals from one another.

18. The method of claim 11, wherein said simulation time is constrained so as not to advance faster than said real time.

19. A computer readable non-transitory storage medium storing instructions of a computer program which when executed by a computer system results in performance of steps of a method for disseminating content, comprising:
simulating operation of said network;
providing simulation time to said components of said network, at discrete moments in real time, to advance time when a simulator conducts operations faster than said real time, and to advance more slowly than said real time when said simulator conducts operations more slowly than said real time.
